(19) United States
(12) Patent Application Publication
(10) Pub. No.: US 2024/0017517 A1
(43) Pub. Date: Jan. 18, 2024

(54) CLAMPABLE, RECYCLABLE THERMOPLASTIC FUEL TUBING FOR LOW-PRESSURE APPLICATIONS

(71) Applicant: GM GLOBAL TECHNOLOGY OPERATIONS LLC, Detroit, MI (US)

(72) Inventor: Dennis M. D'HONDT, Ray, MI (US)

(73) Assignee: GM GLOBAL TECHNOLOGY OPERATIONS LLC, Detroit, MI (US)

(21) Appl. No.: 17/862,904

(22) Filed: Jul. 12, 2022

(51) Int. Cl. B32B 1/08; F16L 11/04; B32B 27/08; B32B 27/34; B32B 27/32; B32B 7/12

(52) U.S. Cl. CPC B32B 1/08; F16L 11/04; B32B 27/08; B32B 27/34; B32B 27/322; B32B 7/12; B32B 2250/02; B32B 2250/03; B32B 2250/24; B32B 2255/10; B32B 2255/26; B32B 2307/732; B32B 2307/308; B32B 2597/00

(57) ABSTRACT

A multilayered tubing for low-pressure fuel applications is provided. The multilayered tubing includes a first thermoplastic layer defining an interior cavity and a second thermoplastic layer encasing the first thermoplastic layer. The first thermoplastic layer includes an extrudable thermoplastic fluoropolymer, and the second thermoplastic layer may include a semi-crystalline thermoplastic polymer. In certain variations, an adhesive is disposed between the first thermoplastic layer and the second thermoplastic layer. In still other variations, a third thermoplastic layer is disposed between the first thermoplastic layer and the second thermoplastic layer. In such instances, a first adhesive can be disposed between the first thermoplastic layer and the third thermoplastic layer and/or a second adhesive can be disposed between the third thermoplastic layer and the second thermoplastic layer.

### INTRODUCTION

This section provides background information related to the present disclosure which is not necessarily prior art.

Tubing is often used to connect different components of a fuel system, and also, to connect the fuel system to other components in a fuel-consuming engine. Fuels, such as petroleum-based fuels, like gasoline and diesel, or biofuels, may be transported as fluids, such as liquid and/or vapor, within the tubing. Thermoplastics can be desirable for fuel tube formation because of lower costs and reduced fuel permeation, for example, as compared to fluoroelastomers. However, thermoplastic fuel tubes are often connected to different components using either permanent connections that make repairs and replacements difficult or quick-connector components that are costly and difficult to package. Accordingly, it would be desirable to develop improve tubing materials and configurations that can address these challenges.

### SUMMARY

This section provides a general summary of the disclosure, and is not a comprehensive disclosure of its full scope or all of its features.

The present disclosure relates to clampable, recyclable thermoplastic tubing for low-pressure applications, and to methods of making and using the same.

In various aspects, the present disclosure provides a multilayered tubing for fuel applications. The multilayered tubing may include a first thermoplastic layer defining an interior cavity and a second thermoplastic layer encasing the first thermoplastic layer. The first thermoplastic layer may include an extrudable thermoplastic fluoropolymer. The second thermoplastic layer may include a semi-crystalline thermoplastic polymer.

In one aspect, the extrudable thermoplastic fluoropolymer may include fluoroplastic-thermoplastic vulcanizate (F-TPV).

In one aspect, the semi-crystalline thermoplastic may be selected from the group consisting of: polyamide 12 (PA12), polyamide 11 (PA11), polyamide 612 (PA612), polyamide 9T (PA9T), polyphthalamide (PPA), polyphenylene sulfide (PPS), and combinations thereof.

In one aspect, the semi-crystalline thermoplastic may include polyamide 12 (PA12) and the fuel applications have continuous operational temperatures below 90° C. and excursion temperatures below 115° C.

In one aspect, the semi-crystalline thermoplastic may include at least one of polyamide 612 (PA612) and polyamide 9T (PA9T) and the fuel applications may have continuous operational temperatures below 120° C. and excursion temperatures below 150° C.

In one aspect, the first thermoplastic layer may have a first average thickness greater than or equal to about 0.05 millimeters to less than or equal to about 0.20 millimeters. The second thermoplastic layer may have a second average thickness greater than or equal to about 0.3 millimeters to less than or equal to about 1 millimeter.

In one aspect, an adhesive may be disposed between the first thermoplastic layer and the second thermoplastic layer.

In one aspect, the adhesive may be selected from the group consisting of: melt processible resins comprising fluorinated compounds, polyamide, and combinations thereof.

In one aspect, the adhesive may define an adhesive layer having an average thickness greater than or equal to about 0.05 millimeters to less than or equal to about 0.20 millimeters.

In one aspect, an intermediate thermoplastic layer may be disposed between the first thermoplastic layer and the second thermoplastic layer.

In one aspect, the intermediate thermoplastic layer may include a polymer selected from the group consisting of: fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), and combinations thereof.

In one aspect, the intermediate layer may have an average thickness greater than or equal to about 0.05 millimeters to less than or equal to about 0.4 millimeters.

In one aspect, an adhesive may be disposed between the intermediate thermoplastic layer and the first thermoplastic layer.

In one aspect, an adhesive may be disposed between the intermediate thermoplastic layer and the second thermoplastic layer.

In various aspects, the present disclosure provides a multilayered tubing for fuel applications. The multilayered tube may include a first thermoplastic layer defining an interior cavity and a second thermoplastic layer encasing the first thermoplastic layer. The first thermoplastic layer may include a fluoroplastic-thermoplastic vulcanizate (F-TPV). The second thermoplastic layer may include a semi-crystalline thermoplastic selected from the group consisting of: polyamide 12 (PA12), polyamide 11 (PA11), polyamide 612 (PA612), polyamide 9T (PA9T), polyphthalamide (PPA), polyphenylene sulfide (PPS), and combinations thereof.

In one aspect, an adhesive may be disposed between the first thermoplastic layer and the second thermoplastic layer.

In one aspect, an intermediate thermoplastic layer may be disposed between the first thermoplastic layer and the second thermoplastic layer. The intermediate thermoplastic layer may include fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), or combinations thereof.

In one aspect, a first adhesive may be disposed between the intermediate thermoplastic layer and the first thermoplastic layer and/or a second adhesive may be disposed between the intermediate thermoplastic layer and the second thermoplastic layer.

In various aspects, the present disclosure provides a multilayered tubing for fuel applications. The multilayered tubing may include a first thermoplastic layer defining an interior cavity, a second thermoplastic layer encasing the first thermoplastic layer, and a third thermoplastic layer encasing the second thermoplastic layer. The first thermoplastic layer may include a fluoroplastic-thermoplastic vulcanizate (F-TPV). The first thermoplastic layer may have a first average thickness. The first average thickness may be greater than or equal to about 0.05 millimeters to less than or equal to about 0.20 millimeters. The second thermoplastic layer may include a polymer selected from the group consisting of: fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), and combinations thereof. The second thermoplastic layer may have a second average thickness. The second average thickness may be greater than or equal to about 0.05 millimeters to less than or equal to about 0.4 millimeters. The third thermoplastic may include a semi-crystalline thermoplastic polymer. The semi-crystalline thermoplastic polymer may be selected from the group consisting of: polyamide 12 (PA12), polyamide 11 (PA11), polyamide 612 (PA612), polyamide 9T (PA9T), polyphthalamide (PPA), polyphenylene sulfide (PPS), and combinations thereof. The third thermoplastic layer may have a third average thickness. The third average thickness may be greater than or equal to about 0.3 millimeters to less than or equal to about 1 millimeter.

In one aspect, a first adhesive may be disposed between the intermediate thermoplastic layer and the first thermoplastic layer and/or a second adhesive may be disposed between the intermediate thermoplastic layer and the second thermoplastic layer.

Corresponding reference numerals indicate corresponding parts throughout the several views of the drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a cross-section illustration of an example clampable, recyclable thermoplastic tubing in accordance with various aspects of the present disclosure; and

FIG. 2 is a cross-section illustration of another example clampable, recyclable thermoplastic tubing in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

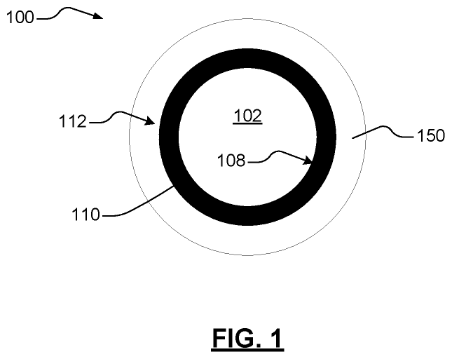

Fuel tubing in accordance with various aspects of the present disclosure may include multiple thermoplastic layers. For example, as illustrated in FIG. 1, an example tubing 100 may include a first (or interior or inner) layer 110 and a second (or exterior or outer) layer 150 that encases (or surrounds) the first layer 110. For example, the second layer 150 may be a substantially continuous coating extruded onto an exterior-facing surface 112 of the first layer 110. Although not illustrated, it should be appreciated that in certain variations an adhesive may be disposed between the first layer 110 and the second layer 150 so as to aid in the bonding of the first and second layers 110, 150. The adhesive may include, for example, melt processible resins comprising fluorinated compounds and/or polyamide. In certain variations, the adhesive may form a continuous adhesive layer between the first layer 110 and the second layer 150. The continuous adhesive layer may have an average thickness greater than or equal to about 0.05 millimeters (mm) to less than or equal to about 0.20 mm, and in certain aspects, optionally greater than or equal to about 0.10 to less than or equal to about 0.15 mm. In other variations, the adhesive may be disposed so as to cover only a portion of the exterior-facing surface 112 of the first layer 110, for example, the adhesive may be disposed to form a selected pattern. In each instance, the inclusion of the adhesive may be particularly beneficial in the instance of higher temperature operations (e.g., greater than 115° C.).

In each variation, the first layer 110 may be a soft thermoplastic layer having, for example, a Shore A hardness greater than or equal to about 60 to less than or equal to about 90 when tested to the requirements of ASTM D2240, the relevant portions of which are incorporated herein by reference. The first layer 100 may also have low fuel permeation rates, for example, one-half or less fuel permeation rate as compared to a comparative fuel permeation rate for a soft thermoset fluoroelastomer rubber. An interior-facing surface 108 of the first layer 110 may define a cavity 102 through with materials (e.g., fuel) may travel. In certain variations, the first layer 110 may include an extrudable thermoplastic fluoropolymer. In certain variations, such an extrudable thermoplastic fluoropolymer may not require any curing, such as a fluoroplastic-thermoplastic vulcanizate (F-TPV), so that the multilayered tubing 100 is readily recyclable using conventional methods and the process for forming the multilayered tubing 100 is simplified. The first layer 110 may have an average thickness greater than or equal to about 0.3 mm to less than or equal to about 3 mm, and in certain aspects, optionally thickness greater than or equal to about 1 mm to less than or equal to about 2 mm; and the cavity 102 may have a diameter greater than or equal to about 4 mm to less than or equal to about 20 mm, and in certain aspects, optionally greater than or equal to about 6 mm to less than or equal to about 17 mm.

In certain variations, the second layer 150 may be a flexible layer comprising a semi-crystalline thermoplastic, such as polyamide 12 (PA12), polyamide 11 (PA11), polyamide 612 (PA612), polyamide 9T (PA9T), polyphthalamide (PPA), and/or polyphenylene sulfide (PPS). In certain variations, the second layer 150 may have a Flexural Modulus greater than or equal to about 0.3 GPa to less than or equal to about 2.0 GPa, when tested to ISO 178. A multilayered tubing 100 having a second layer 150 that includes polyamide 12 (PA12) may have continuous operational temperatures below 90° C. and excursion temperatures below 115° C., whereas a multilayered tubing 100 having a second layer 150 that includes polyamide 612 (PA612) and/or polyamide 9T (PA9T) may have continuous operational temperatures below 120° C. and excursion temperatures below 150° C. In each instance, the second layer 150 may have an average thickness greater than or equal to about 0.3 mm to less than or equal to about 1 mm, and in certain aspects, optionally thickness greater than or equal to about 0.5 mm to less than or equal to about 0.9 mm.

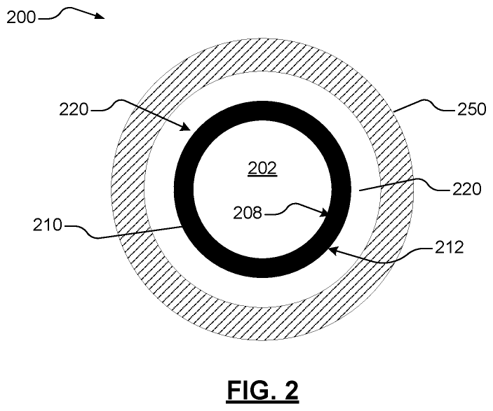

FIG. 2 illustrates another example multilayered tubing 200 that includes a first (or interior or inner) layer 210, a second (or intermediate) layer 220 that encases (or surrounds) the first layer 210, and a third (or exterior or outer) layer 250 that encases (or surrounds) the second layer 220. For example, the second layer 220 may be a substantially continuous coating extruded onto an exterior-facing surface 212 of the first layer 210, and a third layer 250 that may be a substantially continuous coating extruded onto an exterior-facing surface 222 of the second layer 220. Although not illustrated, it should be appreciated that, in certain variations, a first adhesive may be disposed between the first layer 210 and the second layer 210 so as to aid in the bonding of the first and second layers 210, 220 and/or a second adhesive may be disposed between the second layer 220 and the third layer 250 so as to aid in the bonding of the second and third layers 220, 250.

The first and second adhesives may be the same or different. For example, the first and second adhesives may be independently selected from melt processible resins based on fluorinated compounds and/or polyamide. In certain variations, the first adhesive may form a (first) continuous adhesive layer between the first layer 210 and the second layer 220, and/or the second adhesive may form a (second) continuous adhesive layer between the second layer 220 and the third layer 250. The (first) continuous adhesive layer and/or the (second) continuous adhesive layer may have average thicknesses greater than or equal to about 0.05 mm to less than or equal to about 0.20 mm, and in certain aspects, optionally greater than or equal to about 0.10 mm to less than or equal to about 0.15 mm. In other variations, the first adhesive may be disposed so as to cover only a portion of the exterior-facing surface 212 of the first layer 210, for example, the first adhesive may be disposed to form a selected pattern. Similarly, the second adhesive may be disposed so as to cover over a portion of the exterior-facing surface 222 of the second layer 220, for example, the second adhesive may be disposed to form a selected pattern. In each instance, the inclusion of the adhesive(s) may be particularly beneficial in the instance of higher temperature operations (e.g., greater than 115° C.).

The first layer 210 may be a soft thermoplastic layer having, for example, a Shore A hardness greater than or equal to about 60 to less than or equal to about 90 when tested to the requirements of ASTM D2240. The first layer 210 may also have low fuel permeation rates, for example, one-half or less of a fuel permeation rate as compared to a comparative fuel permeation rate for soft thermoset fluoroelastomer rubber. An interior-facing surface 208 of the first layer 210 may define a cavity 202 through with materials (e.g., fuel) may travel. In certain variations, the first layer 210 may include an extrudable thermoplastic fluoropolymer. In certain variations, such an extrudable thermoplastic fluoropolymer may not require any curing, such as a fluoroplastic-thermoplastic vulcanizate (F-TPV), so that the multilayered tubing 200 is readily recyclable using conventional methods and the process for forming the multilayered tubing 200 is simplified. The first layer 210 may have an average thickness greater than or equal to about 0.3 mm to less than or equal to about 3 mm, and in certain aspects, optionally thickness greater than or equal to about 1 mm to less than or equal to about 2 mm; and the cavity 202 may have a diameter greater than or equal to about 4 mm to less than or equal to about 20 mm, and in certain aspects, optionally greater than or equal to about 6 mm to less than or equal to about 17 mm.

The second layer 220 may include another extrudable fluoroplastic that does not require curing. For example, the second layer 220 may include fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), or combinations thereof. The second layer 220 may have an average thickness greater than or equal to about 0.05 mm to less than or equal to about 0.4 mm, and in certain aspects, optionally thickness greater than or equal to about 0.1 mm to less than or equal to about 0.3 mm. Although only one intermediate layer (i.e., second layer 220) is illustrated, it should be recognized that, in certain variations, the multilayered tubing 200 may further include one or more other intermediate layers and that each of the intermediate layers may be optionally coated on one or more sizes with an adhesive so as to improve boning between adjacent intermediate layers and also between the intermediate layers and the inner layer 210 and/or the exterior layer 250.

The third layer 250 may be a semi-crystalline thermoplastic, such as polyamide 12 (PA12), polyamide 11 (PA11), polyamide 612 (PA612), polyamide 9T (PA9T), polyphthalamide (PPA), and/or polyphenylene sulfide (PPS). A multilayered tubing 200 having a third layer 250 that includes polyamide 12 (PA12) may have continuous operational temperatures below 90° C. and excursion temperatures below 115° C., whereas a multilayered tubing 200 having a third layer 250 that includes polyamide 612 (PA612) and/or polyamide 9T (PA9T) may have continuous operational temperatures below 120° C. and excursion temperatures below 150° C. The third layer 250 may have an average thickness greater than or equal to about 0.3 mm to less than or equal to about 1 mm, and in certain aspects, optionally thickness greater than or equal to about 0.5 mm to less than or equal to about 0.9 mm.

In each instance, the softness and flexibility of the multi-layered thermoplastic configuration of the example multilayered tubing 100, 200 allows the multilayered tubing 100, 200 to be easily coupled to different apparatuses, including, for example, between different components of a fuel systems, and also, between a fuel system and other components of the fuel-consuming engine. For example, multilayered tubings, like those illustrated in FIGS. 1 and 2, may be installed by forcing a first end over a formed fitting, such as a metal or plastic tube having a smooth end. The smooth end of the metal or plastic tube may have an expansion portion that is configured to compress one or more layers of the multilayered tubing in an area where a clamp (e.g., mubea clamp, aircraft clamp, oetiker clamp) is also applied.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multilayered tubing for fuel applications, the multilayered tubing comprising:
a first thermoplastic layer defining an interior cavity and comprising an extrudable thermoplastic fluoropolymer; and
a second thermoplastic layer encasing the first thermoplastic layer and comprising a semi-crystalline thermoplastic polymer.

2. The multilayered tubing of claim 1, wherein the extrudable thermoplastic fluoropolymer comprises fluoroplastic-thermoplastic vulcanizate (F-TPV).

3. The multilayered tubing of claim 1, wherein the semi-crystalline thermoplastic is selected from the group consisting of: polyamide 12 (PA12), polyamide 11 (PA11), polyamide 612 (PA612), polyamide 9T (PA9T), polyphthalamide (PPA), polyphenylene sulfide (PPS), and combinations thereof.

4. The multilayered tubing of claim 3, wherein the semi-crystalline thermoplastic comprises polyamide 12 (PA12) and the fuel applications have continuous operational temperatures below 90° C. and excursion temperatures below 115° C.

5. The multilayered tubing of claim 3, wherein the semi-crystalline thermoplastic comprises at least one of polyamide 612 (PA612) and polyamide 9T (PA9T) and the fuel applications have continuous operational temperatures below 120° C. and excursion temperatures below 150° C.

6. The multilayered tubing of claim 1, wherein the first thermoplastic layer has a first average thickness greater than or equal to about 0.05 millimeters to less than or equal to about 0.20 millimeters, and the second thermoplastic layer has a second average thickness greater than or equal to about 0.3 millimeters to less than or equal to about 1 millimeter.

7. The multilayered tubing of claim 1, wherein an adhesive is disposed between the first thermoplastic layer and the second thermoplastic layer.

8. The multilayered tubing of claim 7, wherein the adhesive is selected from the group consisting of: melt processible resins comprising fluorinated compounds, polyamide, and combinations thereof.

9. The multilayered tubing of claim 7, wherein the adhesive defines an adhesive layer having an average thickness greater than or equal to about 0.05 millimeters to less than or equal to about 0.20 millimeters.

10. The multilayered tubing of claim 1, wherein an intermediate thermoplastic layer is disposed between the first thermoplastic layer and the second thermoplastic layer.

11. The multilayered tubing of claim 11, wherein the intermediate thermoplastic layer comprises a polymer selected from the group consisting of: fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), and combinations thereof.

12. The multilayered tubing of claim 11, wherein the intermediate layer has an average thickness greater than or equal to about 0.05 millimeters to less than or equal to about 0.4 millimeters.

13. The multilayered tubing of claim 11, wherein an adhesive is disposed between the intermediate thermoplastic layer and the first thermoplastic layer.

14. The multilayered tubing of claim 11, wherein an adhesive is disposed between the intermediate thermoplastic layer and the second thermoplastic layer.

15. A multilayered tubing for fuel applications, the multilayered tubing comprising:
a first thermoplastic layer defining an interior cavity and comprising a fluoroplastic-thermoplastic vulcanizate (F-TPV); and
a second thermoplastic layer encasing the first thermoplastic layer and comprising a semi-crystalline thermoplastic selected from the group consisting of: polyamide 12 (PA12), polyamide 11 (PA11), polyamide 612 (PA612), polyamide 9T (PA9T), polyphthalamide (PPA), polyphenylene sulfide (PPS), and combinations thereof.

16. The multilayered tubing of claim 15, wherein an adhesive is disposed between the first thermoplastic layer and the second thermoplastic layer.

17. The multilayered tubing of claim 15, wherein an intermediate thermoplastic layer is disposed between the first thermoplastic layer and the second thermoplastic layer, the intermediate thermoplastic layer comprising fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), or combinations thereof.

18. The multilayered tubing of claim 17, wherein at least one of:
a first adhesive is disposed between the intermediate thermoplastic layer and the first thermoplastic layer; and
a second adhesive is disposed between the intermediate thermoplastic layer and the second thermoplastic layer.

19. A multilayered tubing for fuel applications, the multilayered tubing comprising:
a first thermoplastic layer defining an interior cavity and comprising a fluoroplastic-thermoplastic vulcanizate (F-TPV), the first thermoplastic layer having a first average thickness greater than or equal to about 0.05 millimeters to less than or equal to about 0.20 millimeters;
a second thermoplastic layer encasing the first thermoplastic layer and comprising a polymer selected from the group consisting of: fluorinated ethylene propylene (FEP), ethylene tetrafluoroethylene (ETFE), polyvinylidene fluoride (PVDF), polyfluoroalkoxy alkane (PFA), polytetrafluoroethylene (PTFE), and combinations thereof, the second thermoplastic layer having a second average thickness greater than or equal to about 0.05 millimeters to less than or equal to about 0.4 millimeters; and
a third thermoplastic layer encasing the second thermoplastic layer and comprising a semi-crystalline thermoplastic polymer selected from the group consisting of: polyamide 12 (PA12), polyamide 11 (PA11), polyamide 612 (PA612), polyamide 9T (PA9T), polyphthalamide (PPA), polyphenylene sulfide (PPS), and combinations thereof, the third thermoplastic layer having a third average thickness greater than or equal to about 0.3 millimeters to less than or equal to about 1 millimeter.

20. The multilayered tubing of claim 19, wherein at least one of:
a first adhesive is disposed between the intermediate thermoplastic layer and the first thermoplastic layer; and
a second adhesive is disposed between the intermediate thermoplastic layer and the second thermoplastic layer.
